(19) United States
(12) Patent Application Publication
(10) Pub. No.: US 2025/0183297 A1
(43) Pub. Date: Jun. 5, 2025

(54) POSITIVE ELECTRODE ACTIVE MATERIAL, POSITIVE ELECTRODE, BATTERY, AND METHOD FOR PRODUCING LITHIUM-CONTAINING COMPOUND

(71) Applicants: Kyoto University, Kyoto-shi, Kyoto (JP); SUMITOMO CHEMICAL COMPANY, LIMITED, Chuo-ku, Tokyo (JP)

(72) Inventors: Tsutomu YAMABAYASHI, Niihama-shi, Ehime (JP); Hiroshi KAGEYAMA, Kyoto-shi, Kyoto (JP); Cedric TASSEL, Kyoto-shi, Kyoto (JP); Satoru KUZE, Kyoto-shi, Kyoto (JP); Tong ZHU, Kyoto-shi, Kyoto (JP)

(21) Appl. No.: 18/842,898

(22) PCT Filed: Feb. 24, 2023
(86) PCT No.: PCT/JP2023/006869

§ 371 Date: Aug. 30, 2024

(30) Foreign Application Priority Data
Mar. 4, 2022 (JP) 2022-033555

(51) Int. Cl. H01M 4/58; C01G 49/00; H01M 4/02

(52) U.S. Cl. CPC H01M 4/5815; C01G 49/009; C01P 2002/50; C01P 2002/72; C01P 2002/77; C01P 2006/40; H01M 2004/028

(57) ABSTRACT

Provided is a positive electrode active material containing a compound containing an alkaline metal that is represented by the following Compositional Formula (1), and has a chain structure in which MX₄ tetrahedrons are connected to each other by edge-sharing in a crystal structure.

AₐM_{b}X₄ (1)
(In Formula (1), A is an alkaline metal element, M is a transition metal element, X is at least one of S and Se, and relationships of 0<a<5 and 1<b≤2.5 are satisfied.)

### TECHNICAL FIELD

The present disclosure relates to a positive electrode active material, a positive electrode, and a battery.

### BACKGROUND ART

There are known secondary batteries in which charging and discharging are performed when alkaline metal ions move between a positive electrode and a negative electrode (Patent Literature 1 and Non Patent Literature 1). Among the secondary batteries, lithium ion secondary batteries are representative, and have already been put into practical use as small-sized power supplies of mobile phones, notebooks, and the like, and the demand for the lithium ion secondary batteries are increasing because the lithium ion secondary batteries can be used as large-sized power supplies such as power supplies for automobiles such as electric vehicles and hybrid vehicles, or distributed power storage power supplies. However, in the lithium ion secondary batteries, since a large amount of raw materials containing rare metal elements such as lithium is used when producing materials constituting the lithium ion secondary batteries, there is a concern about supply of the raw materials for meeting the increase in the demand for the large-sized power supplies.

In addition, recently, sodium ion secondary batteries also have attracted attention. Sodium belonging to the same alkaline metal as in lithium is more abundant as a resource as compared with lithium and is more inexpensive by one digit than lithium. In addition, since sodium has a relatively high standard potential, the sodium ion secondary batteries are considered to be secondary batteries with high-capacity.

### CITATION LIST

### Patent Literature

Patent Literature 1: International Publication WO 2010/084808

### Non Patent Literature

Non Patent Literature 1: Journal of Materials Chemistry A, 2015, issue 15, pp. 7689 to 7694.

### SUMMARY OF INVENTION

### Technical Problem

Here, as materials of an electrode active material for the above secondary batteries, materials of electrode active materials of sulfides or selenides such as TiS₂, FeS₂, and FeSe₂ are known. The materials of the electrode active materials of the sulfides or selenides have advantages that the materials are soft, are easily form an interface with a solid electrolyte, are more susceptible to oxidation and reduction of anion species as compared with oxide-based materials, and are expected to produce a high-capacity materials, but there are few examples of materials that inherently contain an alkali metal. In a case of using a compound that does not contain an alkaline metal such as TiS₂, FeS₂, and FeSe₂ as a positive electrode, if the compound is not combined with a highly active negative electrode material containing an alkaline metal such as metallic lithium as a negative electrode, a function as a battery cannot be accomplished, and thus there is a risk of occurrence of dendrite.

The present invention has been made in consideration of such circumstances, and an object thereof is to provide a positive electrode active material capable of being combined with a negative electrode that does not contain an alkaline metal, a positive electrode containing the positive electrode active material, and a battery. In addition, another object of the present disclosure is to provide a method for producing a compound containing a lithium capable of being combined with the negative electrode that does not contain the alkaline metal.

### Solution to Problem

A positive electrode active material according to the present disclosure contains a compound containing an alkaline metal represented by the following Compositional Formula (1), and having a chain structure in which MX₄ tetrahedrons are connected to each other by edge-sharing in a crystal structure.

AₐM_{b}X₄ (1)

(In Formula (1), A is an alkaline metal element, M is a transition metal element, X is at least one of S and Se, and relationships of 0<a<5 and 1<b≤2.5 are satisfied.)
X may include S.
A may be Na.

The compound containing an alkaline metal may be a compound (A) represented by the following Compositional Formula (2).

Liₐ₁Naₐ₂M_{b1}X₄ (2)

(In Formula (2), relationship of 0≤a1≤4, 0≤a2≤4, 1.35≤b1≤2.5, 0<a1+a2<5 are satisfied, M is a transition metal element, and X is at least one of S and Se.)

M may include at least one kind of metal element selected from the group consisting of Fe, Ni, Mn, and Co.

A positive electrode according to the present disclosure may include the positive electrode active material.

A battery according to the present disclosure may include the positive electrode.

A method for producing a compound containing a lithium according to the present disclosure includes a step of substituting at least a part of sodium contained in a sodium-containing compound with lithium by performing charging and discharging on an electrochemical cell including,
a positive electrode containing the sodium-containing compound represented by the following Compositional Formula (4), and having a chain structure in which MX₄ tetrahedrons are connected to each other by edge-sharing in a crystal structure,

Aₐ₃M_{b2}X₄ (4)

(In Formula 4, A is an alkaline metal element including sodium, M is a transition metal element, X is at least one of S and Se, and relationships of 0<a3<5 and 1<b2≤2.5 are satisfied),
a negative electrode that contains lithium, and
an electrolyte that is disposed between the positive electrode and the negative electrode, and contains lithium ions.

### Advantageous Effects of Invention

According to the present disclosure, it is possible to provide a positive electrode active material capable of being combined with a negative electrode that does not contain an alkaline metal, a positive electrode containing the positive electrode active material, and a battery. In addition, according to the present disclosure, it is possible to provide a method for producing a compound containing a lithium capable of being combined with the negative electrode that does not contain the alkaline metal.

### BRIEF DESCRIPTION OF DRAWINGS

FIG. 1 is a view illustrating results of structure analysis on a sodium-containing sulfide of Example 1.

FIG. 2 is an X-ray diffraction chart of a positive electrode after charging and discharging of a Li half-cell prepared by using the sodium-containing sulfide of Example 1.

### DESCRIPTION OF EMBODIMENTS

A positive electrode active material of an embodiment contains a compound containing an alkaline metal represented by the following Compositional Formula (1), and having a chain structure in which MX₄ tetrahedrons are connected to each other by edge-sharing in a crystal structure.

AₐM_{b}X₄ (1)

(In Formula (1), A is an alkaline metal element, M is a transition metal element, X is at least one of S and Se, and relationships of 0<a<5 and 1<b≤2.5 are satisfied.)

The positive electrode active material may contain one kind of the compound containing an alkaline metal, or two or more kinds of the compound containing an alkaline metal having compositions different from each other. Note that, the edge-sharing represents that MX₄ tetrahedrons share an edge line.

In Formula (1), A may be any of Li, Na, K, Rb, and Cs, but may be Li, Na, or K, or Li or Na. That is, A may contain at least one kind selected from the group consisting of Li, Na, K, Rb, and Cs, may contain at least one kind selected from the group consisting of Li, Na, and K, or may contain at least one selected from Li and Na. A may contain Na. A may contain Li. The alkaline metal element contained in the positive electrode active material may be only one kind. In this case, for example, the largest amount of an alkaline metal contained in the positive electrode active material with respect to a total amount of alkaline metals contained in the positive electrode active material may be 90 mol % or more, 95 mol % or more, 97 mol % or more, or 99 mol % or more.

In Formula (1), M may include at least one kind of metal element selected from the group consisting of Fe, Ni, Mn, and Co, and may include Fe.

In Formula (1), X may include S.

The compound containing an alkaline metal may be an alkaline metal-containing sulfide.

The compound containing an alkaline metal may be a sodium-containing compound or a sodium-containing sulfide. Examples of the sodium-containing sulfide include Na₃Fe₂S₄ and the like. Examples of a sodium-containing selenide include Na₃Fe₂Se₄ and the like.

The compound containing an alkaline metal may be a lithium-containing compound or a lithium-containing sulfide. Examples of the lithium-containing sulfide include Li₃Fe₂S₄ and the like. Examples of a lithium-containing selenide include Li₃Fe₂Se₄ and the like.

In Formula (1), a may be 1 to 4.8, 2 to 4.3, or 2.5 to 3.5. b may be 1.5 to 2.5, or 1.7 to 2.2.

The positive electrode active material may contain an iron sulfide, or may not contain the iron sulfide. Here, the iron sulfide in this specification represents a compound consisting of iron and sulfur, and specific examples thereof include FeS (iron sulfide (II)), Fe₂S₃ (iron sulfide (III)), FeS₂ (iron disulfide), and the like. The amount of the iron sulfide contained in the positive electrode active material may be 8 mass or less, 5 mass % or less, 3 mass % or less, or 1 mass % or less with respect to a total amount of the positive electrode active material.

The amount of FeS₂ contained in the positive electrode active material may be 8 mass or less, 5 mass % or less, 3 mass % or less, or 1 mass % or less with respect to a total amount of the positive electrode active material.

The amount of the compound containing an alkaline metal contained in the positive electrode active material may be 90 mass % or more, 93 mass % or more, or 95 mass % or more.

The compound containing an alkaline metal may be a compound (A) represented by the following Compositional Formula (2).

Liₐ₁Naₐ₂M_{b1}X₄ (2)

(In Formula (2), relationship of 0≤a1≤4, 0≤a2≤4, 1.0≤b1≤ 2.5, 0<a1+a2<5 are satisfied, M is a transition metal element, and X is at least one of S and Se.)

The compound (A) has a chain structure in which MX₄ tetrahedrons are connected to each other by edge-sharing in a crystal structure.

In Formula (2), a1+a2 may be 1 to 4.8, 2 to 4.3, or 2.5 to 3.5. b1 may be 1.35 to 2.5, 1.5 to 2.5, or 1.7 to 2.2. The compound (A) may be Li₃Fe₂S₄.

In Formula (2), a1 may be 1 to 4.8, 1.2 to 3.0, 1.3 to 2.5, or 1.5 to 2.0.

In Formula (2), a2 may be 0.2 to 3.0, 0.5 to 2.5, 0.8 to 2.0, or 1.0 to 1.5.

Although a method for producing the compound containing an alkaline metal is not particularly limited, for example, a compound containing an alkaline metal that contains an alkaline metal other than lithium can be produced by a method in which an alkaline metal sulfide or selenide, and a transition metal sulfide or selenide are mixed with each other, and the resultant mixture is heated. Examples of the alkaline metal sulfide include Na₂S, K₂S, and the like. Examples of the alkaline metal selenide include Na₂Se, K₂Se, and the like. Examples of the transition metal sulfide include MnS, CoS, NiS, FeS, and the like. Examples of the transition metal selenide include MnSe, CoS, NiSe, FeSe, and the like. A heating temperature may be 700 to 1100° C., or 800 to 1000° C.

In a case where the alkali metal compound is a compound containing a lithium, examples of a production method thereof include a method in which an alkaline metal of the compound containing an alkaline metal that contains an alkaline metal other than lithium is electrochemically substituted with lithium. For example, in the method, first, a sodium-containing compound represented by the following Compositional Formula (4) and having a chain structure in which MX₄ tetrahedrons are connected to each other by edge-sharing in a crystal structure is prepared.

Aₐ₃M_{b2}X₄ (4)

(In Formula 4, A is an alkaline metal element including sodium, M is a transition metal element, X is at least one of S and Se, and relationships of 0<a3<5 and 1<b2≤2.5 are satisfied),

In Compositional Formula (4), a3 may be 1 to 4.8, 2 to 4.3, or 2.5 to 3.5. b2 may be 1.35 to 2.5, 1.5 to 2.5, or 1.7 to 2.2. In a total amount of the alkaline metal elements contained in the compound represented by Compositional Formula (4), a ratio of sodium may be 80 mol % or more, 90 mol % or more, or 95 mol % or more. The compound represented by Formula (4) may be Na₃Fe₂S₄.

Next, a positive electrode that includes the sodium-containing compound is prepared, and an electrochemical cell is assembled by using the positive electrode, a negative electrode (for example, a metal lithium) that contains lithium, and an electrolyte that is disposed between the positive electrode and the negative electrode, and contains lithium ions. When performing charging and discharging on the prepared electrochemical cell, sodium in the sodium-containing compound is substituted with lithium, and a corresponding lithium-containing compound can be obtained. In the production method, at least a part of sodium of the compound represented by Compositional Formula (4) may be substituted. That is, the production method may be a method for producing a positive electrode active material containing the compound represented by Compositional Formula (4) and a compound in which sodium of the compound represented by Compositional Formula (4) is substituted with lithium. The amount of lithium contained in the produced positive electrode active material (a ratio of substitution with lithium) may be 40 mol % or more, 45 mol % or more, or 50 mol % or more, and may be 90 mol % or less with respect to a total amount of sodium and lithium contained in the positive electrode active material. The amount of lithium contained in the produced positive electrode active material (the ratio of substitution with lithium) may be 40 to 90 mol %, or 45 to 80 mol % with respect to a total amount of sodium and lithium contained in the positive electrode active material.

The electrolyte that contains lithium ions may be an electrolytic solution that contains a lithium salt, or the like. Examples of the lithium salt include lithium iodide, lithium tetrafluoroborate, lithium hexafluorophosphate, lithium bis(fluorosulfonyl)imide, lithium bis(trifluoromethylsulfonyl)imide, and the like. Examples of a solvent contained in the electrolytic solution include an organic solvent contained in the following electrolytic solution.

The positive electrode active material of this embodiment can be used as a positive electrode material of a battery, a capacitor, and the like. The battery may be a primary battery or a secondary battery, and may be a battery in which a current is generated due to movement of alkaline metal ions of a lithium ion battery, a sodium ion battery, and the like.

The battery of this embodiment includes a positive electrode, a negative electrode, and an electrolyte disposed between the positive electrode and the negative electrode.

The positive electrode of this embodiment includes the positive electrode active material. The positive electrode includes a current collector, and a positive electrode mixture carried on the current collector. The positive electrode mixture may form a positive electrode mixture layer on the current collector.

The positive electrode mixture contains the positive electrode active material, and may contain a conductive material, a binder, and the like as necessary.

Examples of the conductive material include carbon materials such as natural graphite, artificial graphite, cokes, and carbon black. Examples of the binder include a thermoplastic resin, and specific examples thereof include fluorine resins such as polyvinylidene fluoride (hereinafter, also referred to as “PVDF”), polytetrafluoroethylene, tetrafluoroethylene-hexafluoropropylene-vinylidene fluoride-based copolymer, hexafluoropropylene-vinylidene fluoride-based copolymer, tetrafluoroethylene-perfluorovinyl ether-based copolymer, polyolefin resins such as polyethylene and polypropylene, and the like. As the current collector, Al, Ni, stainless steel, or the like can be used.

Examples of a method of carrying the positive electrode mixture on the current collector include a pressure molding method, a method in which an electrode mixture is made into paste by using an organic solvent or the like, is applied onto the current collector, is dried, and is pressed to adhere to the current collector. In a case of forming paste, for example, a slurry is prepared from the positive electrode active material, the conductive material, the binder, and the organic solvent. Examples of the organic solvent include amine-based solvents such as N,N-dimethylaminopropylamine or diethyltriamine; ether-based solvents such as ethylene oxide or tetrahydrofuran; ketone-based solvent such as methyl ethyl ketone; ester-based solvents such as methyl acetate; aprotic polar solvent such as dimethylacetamide and N-methyl-2-pyrrolidone, and the like. Examples of a method of applying the electrode mixture onto the current collector include slit die coating, screen coating, curtain coating, knife coating, gravure coating, electrostatic spraying, and the like.

The negative electrode of the battery is not particularly limited, and may be a negative electrode that includes a negative electrode active material, and contains a conductive auxiliary agent, a binder, and the like as necessary. For example, in a case of a negative electrode of a lithium ion battery, examples of the material of the negative electrode include metals such as Li, Si, Sn, Si—Mn, Si—Co, Si—Ni, In, and Au, alloys containing these metals, carbon materials such as graphite, and substances in which lithium ions are intercalated between layers of the carbon materials. In a case of a negative electrode of a sodium ion battery, a substance in which Li of the substance exemplified as the negative electrode material of the lithium ion battery is substituted with Na can be used as the negative electrode material.

The electrolyte of the battery is not particularly limited, and an electrolytic solution in which an alkaline metal salt is dissolved in an organic solvent can be used. In addition, the electrolyte may be a solid electrolyte. Examples of the alkaline metal salt include an iodide salt, a tetrafluoroborate salt, a hexafluorophosphate salt, a bis(fluorosulfonyl)imide salt, a bis(trifluoromethylsulfonyl)imide salt, and the like.

The organic solvent contained in the electrolytic solution is not particularly limited, and nonaqueous solvents, for example, cyclic carbonate esters such as ethylene carbonate (EC) and propylene carbonate (PC), straight-chain carbonate esters such as dimethyl carbonate (DMC), diethyl carbonate (DEC), and ethyl methyl carbonate (EMC), sultones, and the like can be exemplified. The solvents may be used alone or in combination of two or more kinds.

### EXAMPLES

### Example 1

0.1895 g of sodium sulfide (Na₂S) powder and 0.3557 g of ferrous sulfide (FeS) powder were mixed together. The resultant mixture was heated at 900° C. in a vacuum for 20 hours to obtain 1.05 g of a positive electrode active material that contains sodium-containing sulfide.

### <X-Ray Diffraction>

Powder X-ray diffraction measurement was performed on the obtained positive electrode active material by using a powder X-ray diffraction measurement device (SmartLab type manufactured by Rigaku

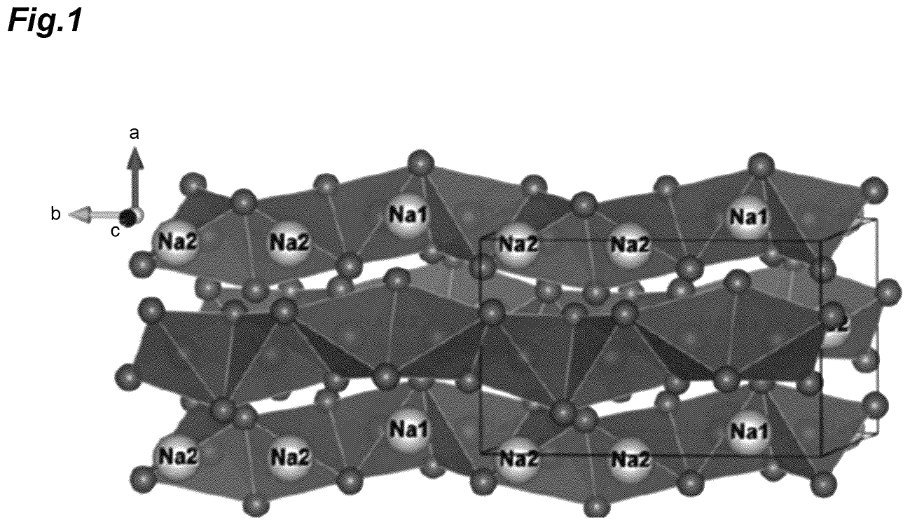

Corporation). The measurement was performed at room temperature by filling the active material in a dedicated substrate equipped with Teflon (registered trademark) tape on a sample to protect the active material from air and moisture and by using a CuKα radiation source at an output of 50 kV and 40 mA, in a range of diffraction angle 2θ of 5° to 80°, at 0.02° step, and at a rate of 3°/minute. From a diffraction pattern, it could be seen that the sodium-containing sulfide has a crystal structure belonging to a space group Pₙₘₐ. A composition of the produced sodium-containing sulfide was Na₃Fe₂S₄, and 4 mass % of iron was contained with respect to a total amount of the positive electrode active material. FIG. 1 is a view illustrating results of crystal structure analysis of the sodium-containing sulfide. As illustrated in FIG. 1, a chain structure in which FeS₄ tetrahedrons are connected to each other by edge-sharing along a b-axis was confirmed. In addition, two types of sites occupied by Na exist and the sites are described in FIG. 1 as “Na1” and “Na2”, respectively.

### <Charging and Discharging Performance Evaluation>

### (1) Preparation of Positive Electrode

The positive electrode active material of Example 1, acetylene black (product name: HS-100, manufactured by Denka Company Limited) as a conductive material, and polytetrafluoroethylene (PTFE, product number: 6-J, Chemours-Mitsui Fluoroproducts Co., Ltd.) as a binder were weighed to be a composition of positive electrode active material:conductive material:binder=70:20:10 (mass ratio). First, the positive electrode active material and the conductive material were thoroughly mixed in an agate mortar, the binder was added to the mixture, and the resultant mixture was further mixed. 7 mg of mixture was weighed and was stretched into a circle on the mortar. The stretched mixture was pressed onto an aluminum mesh (100 mesh, manufactured by The Nilaco Corporation) having a thickness of 110 μm that is a current collector to obtain a positive electrode including the positive electrode active material.

### (2) Preparation and Evaluation of Li Half Cell

A coin-type battery CR2032 type was assembled by using the positive electrode, a polyethylene porous film (thickness: 16 μm) as a separator, a 1 M LiPF₆ solution (a solvent was a mixed solvent containing ethylene carbonate (EC), dimethyl carbonate (DMC), and ethyl methyl carbonate (EMC) as nonaqueous electrolytic solution in a volume ratio of 30:35:35), and metallic lithium as a counter electrode. Note that, the battery was assembled in a glove box kept in an argon atmosphere. A charging and discharging test was performed under the following conditions by using the prepared coin-type battery at 25° C. in a range of a voltage of 2.0 to 3.0 V (capacity: 0 to 150 mAh/g). Measurement results of the initial charging and discharging capacity are shown in Table 1.

Charging and discharging conditions: constant current (CC) charging was performed at 15 mA/g for 10 hours.

Discharging conditions: constant current (CC) discharging was performed at 15 mA/g for 10 hours.

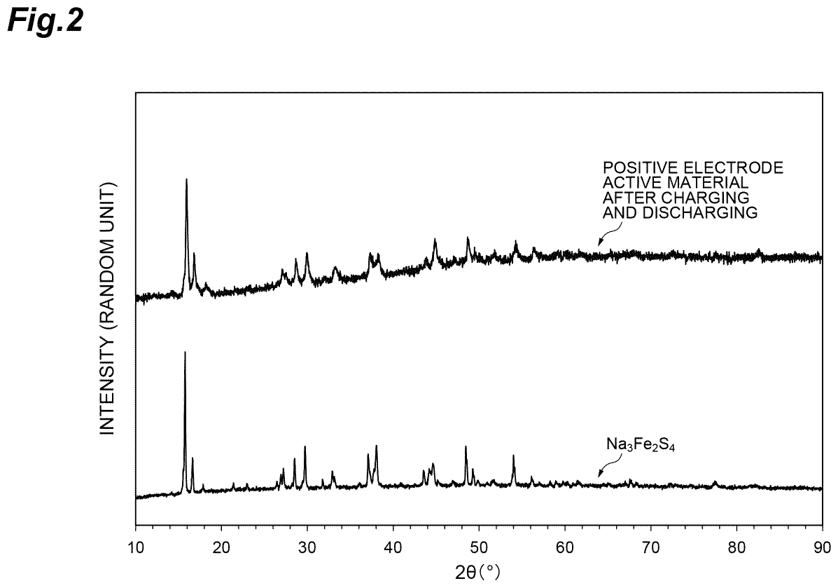

It was considered that in the initial stage of charging, Na was extracted from the crystal structure due to oxidation of Fe in the positive electrode active material. A formal oxidation number of Fe in Na₃Fe₂S₄ that is a positive electrode active material before initiation of charging was 2.5+, but at a charging capacity of 87 mAh/g, the formal oxidation number of Fe became 3+. Typically, since it is not widely known that Fe in the positive electrode active material has an oxidation number of 3+ or more, it is considered that S that is an anion species in the positive electrode active material is oxidized during charging at a charging capacity of 87 mAh/g or more. It was considered that during discharging, Li contained in the electrolytic solution was intercalated into crystals of the positive electrode active material, and Fe and S were reduced. From the charging and discharging capacity in the Li half cell test, it was considered that the composition of the positive electrode active material after the test was Li_{1.72}Na_{1.27}Fe₂S₄. The electrode after the charging and discharging was collected, the mixture containing the active material was peeled from the electrode, and XRD measurement was performed. From the measurement, the same pattern as in Na₃Fe₂S₄ Was observed. FIG. 2 shows an XRD diffraction chart of the positive electrode before and after charging and discharging. A position of an XRD peak of the mixture before and after charging and discharging was observed on a high angle side as compared with Na₃Fe₂S₄, and it was confirmed that deintercalation of Na and intercalation of Li occurred on the basis of a structure belonging to a space group Pₙₘₐ of Na₃Fe₂S₄ during charging and discharging. In Na₃Fe₂S₄ before charging and discharging, lattice constants were a=6.631 (5), b=10.629 (17), c=10.688 (12), whereas after charging and discharging, the lattice constants were a=6.6 (3), b=9.4 (18), and c=10.4 (5), and contraction of the lattice due to substitution of Na with Li was observed (units of all lattice constants are Å).

### (3) Preparation and Evaluation of Na Half Cell

A coin-type battery CR2032 type was assembled by using the positive electrode, a polyethylene porous film (thickness: 16 μm) as a separator, a 1 M sodium bis(trifluoromethylsulfonyl)imide (NaTFSA) solution (a solvent was propylene carbonate (PC)) as a nonaqueous electrolytic solution, and metallic sodium as a counter electrode. Note that, the battery was assembled in a glove box kept in an argon atmosphere. A charging and discharging test was performed under the following conditions by using the prepared coin-type battery at 25° C. in a range of a voltage of 1.5 to 3.0 V. Measurement results of the initial charging and discharging capacity are shown in Table 1.

Charging and discharging conditions: constant current (CC) charging was performed at 15 mA/g.

Discharging conditions: constant current (CC) discharging was performed at 15 mA/g.

### (4) Preparation and Evaluation of Full Cell

### Preparation of Negative Electrode:

Hard carbon (product name: Kuranode, manufactured by Kuraray Co., Ltd.) and an N-methyl-2-pyrrolidone (NMP) solution containing 12 mass % of polyvinylidene fluoride (PVDF) were weighed so that a ratio of the hard carbon and PVDF was 94:6 (mass ratio), and an appropriate amount of NMP (manufactured by FUJIFILM Wako Pure Chemical Corporation) was added and mixed uniformly to prepare paste for a negative electrode. The obtained paste for a negative electrode was applied onto copper foil having a thickness of 40 μm as a current collector by using an applicator at the carrying amount of 3.5 mg/cm² (dried weight). The current collector applied with the paste for a negative electrode was put into a drier kept at 60° C., and was dried while removing NMP. An electrode sheet after drying was roll pressed, and was additionally dried in a vacuum drier kept at 150° C. for 8 hours to obtain an electrode sheet. The electrode sheet was punched out to a diameter of 14.5 mm by using an electrode punching device to obtain a negative electrode including the negative electrode active material.

### Preparation of Positive Electrode:

A positive electrode was prepared by adjusting an active material weight during preparation of the positive electrode so that A/C becomes 1.25 when a value obtained by multiplying the amount of the negative electrode active material by 300 is set as A, and a value obtained by multiplying the amount of the positive electrode active material by 70 is set as C.

A coin-type battery CR2032 type was assembled by using the positive electrode, a polyethylene porous film (thickness: 16 μm) as a separator, a 1 M sodium bis(trifluoromethylsulfonyl)imide (NaTFSA) solution (a solvent was propylene carbonate (PC)) as a nonaqueous electrolytic solution, and the negative electrode. Note that, the battery was assembled in a glove box kept in an argon atmosphere. A charging and discharging test was performed under the following conditions by using the prepared coin-type battery at 25° C. in a range of a voltage of 1.5 to 3.0 V.

Charging and discharging conditions: constant current-constant voltage (CC-CV) charging was performed at 15 mA/g.

Discharging conditions: constant current (CC) discharging was performed at 15 mA/g. Results are shown in Table 1.

### Comparative Example 1

A positive electrode was prepared in a similar manner as in Example 1 except that FeS₂ was used instead of the positive electrode active material of Example 1. A full cell was prepared by using the prepared positive electrode in a similar manner as in (4), and a charging and discharging test was performed. Measurement results of initial charging and discharging capacity and second charging and discharging capacity are shown in Table 1.

TABLE 1

| | | | Example | Comparative |
|---|---|---|---|---|
| Cell | | | 1 | Example 1 |
| Full cell | Initial | Charging | 87 | 0 |
| evaluation | capacity | Discharging | 27 | 0 |
| | (mAh/g) | | | |
| | Second | Charging | 87 | 0 |
| | capacity | Discharging | 48 | 0 |
| | (mAh/g) | | | |
| Li half cell | Initial | Charging | 150 | — |
| | capacity | Discharging | 150 | — |
| | (mAh/g) | | | |
| Na half cell | Initial | Charging | 73 | — |
| | capacity | Discharging | 76 | — |
| | (mAh/g) | | | |

1. A positive electrode active material comprising:
a compound containing an alkaline metal represented by the following Compositional Formula (1), and having a chain structure in which MX₄ tetrahedrons are connected to each other by edge-sharing in a crystal structure.
AₐM_{b}X₄ (1)
(In Formula (1), A is an alkaline metal element, M is a transition metal element, X is at least one of S and Se, and relationships of 0<a<5 and 1<b≤2.5 are satisfied).

2. The positive electrode active material according to claim 1,
wherein X includes S.

3. The positive electrode active material according to claim 1,
wherein A is Na.

4. The positive electrode active material according to claim 1, wherein the compound containing an alkaline metal is represented by the following Compositional Formula (2).
Liₐ₁Naₐ₂M_{b1}X₄ (2)
(In Formula (2), relationship of 0≤a1≤4, 0≤a2≤4, 1.35≤b1≤2.5, 0<a1+a2<5 are satisfied, M is a transition metal element, and X is at least one of S and Se).

5. The positive electrode active material according to claim 1,
wherein M includes at least one kind of metal element selected from the group consisting of Fe, Ni, Mn, and Co.

6. A positive electrode comprising:
the positive electrode active material according to claim 1.

7. A battery comprising:
the positive electrode according to claim 6.

8. A method for producing a compound containing a lithium, comprising:
a step of substituting at least a part of sodium contained in a sodium-containing compound with lithium by performing charging and discharging on an electrochemical cell including,
a positive electrode containing the sodium-containing compound represented by the following Compositional Formula (4), and having a chain structure in which MX₄ tetrahedrons are connected to each other by edge-sharing in a crystal structure,
Aₐ₃M_{b2}X₄ (4)
(In Formula 4, A is an alkaline metal element including sodium, M is a transition metal element, X is at least one of S and Se, and relationships of 0<a3<5 and 1<b2≤2.5 are satisfied),
a negative electrode that contains lithium, and
an electrolyte that is disposed between the positive electrode and the negative electrode, and contains lithium ions.
